(19) United States
(12) Patent Application Publication
(10) Pub. No.: US 2008/0263123 A1
(43) Pub. Date: Oct. 23, 2008

(54) Method and system for determining a minimum number and a penultimate minimum number in a set of numbers

(76) Inventor: Paul Penzes, Newport Beach, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/789,266

(22) Filed: Apr. 23, 2007

(51) Int. Cl. G06F 7/50

(52) U.S. Cl. 708/671

(57) ABSTRACT

There is provided a system for determining a minimum number and a penultimate minimum number in a set of numbers. According to one embodiment, the system includes a first comparator module configured to receive a first subset of the set of numbers and to compare the first subset to determine a first minimum number and a first penultimate minimum number. The system also includes a second comparator module configured to receive a second subset of the set of numbers and to compare the second subset to determine a second minimum number and a second penultimate minimum number. The system further includes a third comparator module configured to receive and compare the first and second minimum numbers and the first and second penultimate minimum numbers to determine the minimum number and the penultimate minimum number in the set of numbers.

### BACKGROUND OF THE INVENTION

1. Field of the Invention

The present invention relates generally to techniques for analyzing numbers. More particularly, the present invention relates to techniques for efficient determination of a minimum number and penultimate minimum number in a set of numbers.

2. Background Art

As the speed and power of modern computers continues to increase at a rapid pace, there is an ever-growing need for higher speed and more reliable data transmission techniques. One such technique involves the use of a low-density parity-check code (LDPC code), which is an error correcting code that enables the reliable transmission of data over a noisy transmission channel. For example, LDPC codes can substantially reduce the probability of data loss during data transmission and can allow data transmission rates close to the theoretical maximum, the Shannon Limit. As such, LDPC is considered to be the most effective error coding code developed to date.

Belief propagation is a commonly used algorithm for LDPC decoding. The belief propagation algorithm includes iteratively updating the probability value of each received bit using the parity check equations that the bit participates in. This algorithm is also referred to as “message-passing decoding” because intrinsic information is passed as messages between the check nodes and the bit nodes. The check nodes correspond to rows in the parity check matrix while the bit nodes correspond to the columns. Thus, an iteration of the belief propagation algorithm would consist of check node updates on all the rows followed by bit node updates on all the columns. Each check node update can be performed using a suitable computation, such as a min-sum algorithm. The min-sum algorithm is an approximation of the sum-product algorithm, which is designed to reduce the amount of hardware required.

A successful implementation of the min-sum algorithm, however, requires a high-speed computation of the minimum number and the penultimate minimum number in a set of numbers, which are used in the min-sum computation. Since the set of numbers from which the minimum and penultimate minimum must be determined can be very large, e.g., 32 unsigned numbers, typical techniques and circuit implementations for determining the minimum number and penultimate minimum number in a set of numbers are generally too slow and cumbersome, and thus impractical for many applications.

### SUMMARY OF THE INVENTION

There is provided methods and systems for determining a minimum number and a penultimate minimum number in a set of numbers, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a block diagram of a comparator module for determining a minimum number and a penultimate minimum number in a set of numbers, in accordance with one embodiment of the invention;

FIG. 2 shows a minimum number module, in accordance with one embodiment of the invention;

FIG. 3 shows a penultimate minimum number module, in accordance with one embodiment of the invention;

FIG. 4 shows a block diagram of an ordered comparator module for determining a minimum number and a penultimate minimum number in a set of numbers, in accordance with one embodiment of the invention;

FIG. 5 shows a system for determining a minimum number and a penultimate minimum number in a set of numbers, in accordance with one embodiment of the present invention;

FIG. 6 illustrates a flowchart of a method for determining a minimum number and a penultimate minimum number in a set of numbers, in accordance with one embodiment of the invention; and

FIG. 7 shows a system for determining the minimum number and the penultimate minimum number in a set of 32 numbers, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

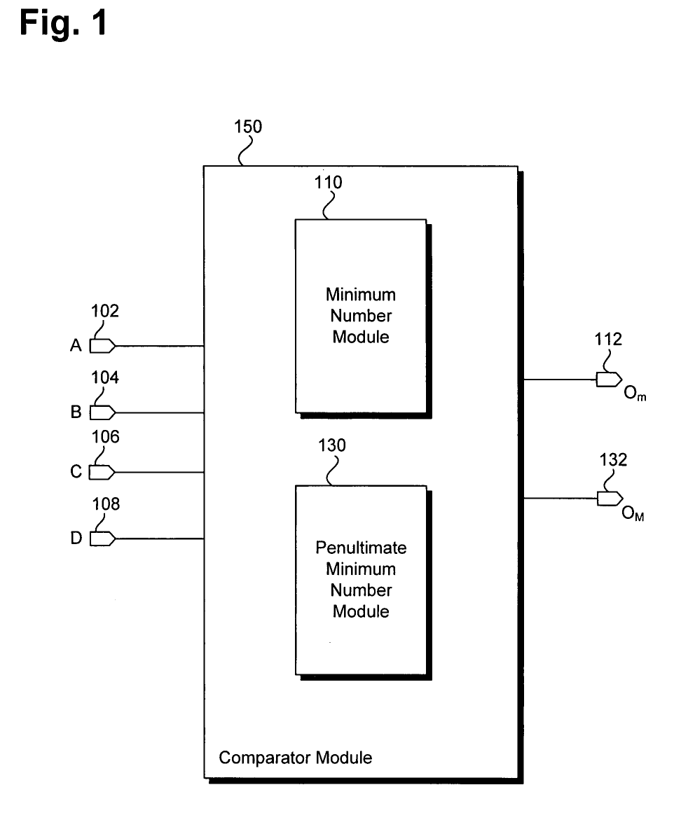

FIG. 1 shows a block diagram of a comparator module for determining a minimum number and a penultimate minimum number in a set of numbers in accordance with one embodiment of the invention. As shown in FIG. 1, comparator module 150 includes inputs 102, 104, 106, and 108 (hereinafter “inputs 102 through 108”), minimum number module 110, minimum number output (“Oₘ”) 112, penultimate minimum number module 130, and penultimate minimum number output (“O_{M}”) 132.

As shown in FIG. 1, comparator module 150 can be configured to receive a set of numbers (e.g., the numbers represented by the variables A, B, C, and D) at inputs 102 through 108. For example, A, B, C, and D can each represent an unsigned number having an “n” number of bits. In one embodiment, A, B, C, and D can each be a 7-bit number. As discussed below, comparator module 150 can be configured to use minimum number module 110 to determine the minimum number (i.e., the lowest number) in the set of numbers, and penultimate minimum number module 130 to determine the penultimate minimum number (i.e., the second lowest number) in the set of numbers. As shown in FIG. 1, the minimum number and the penultimate minimum number in the set of numbers can be output by comparator module 150 at Oₘ 112 and O_{M} 132, respectively.

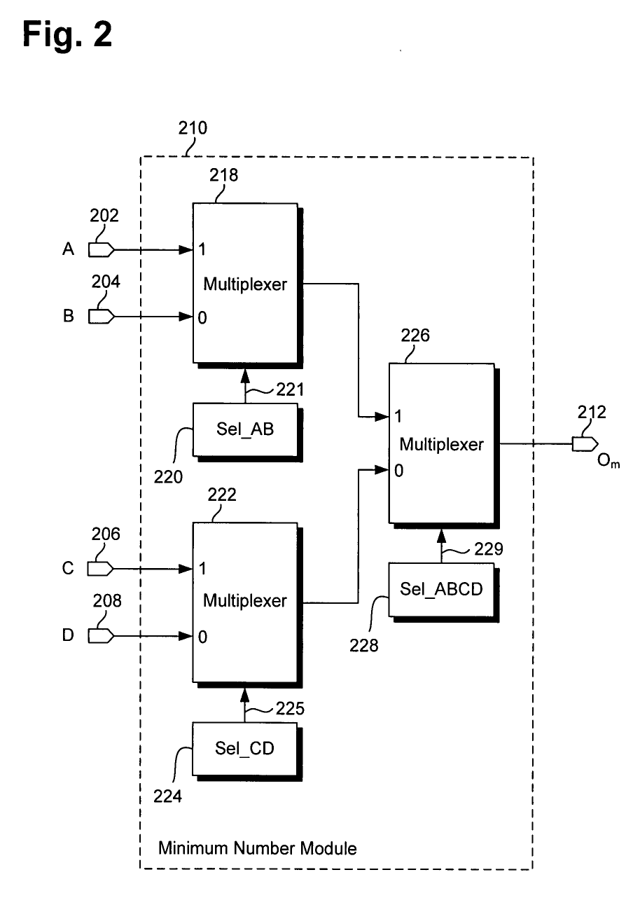

The operation of minimum number module 110 shown in FIG. 1 will now be discussed with reference to FIG. 2. FIG. 2 shows a minimum number module in accordance with one embodiment of the invention. As shown in FIG. 2, minimum number module 210 includes inputs 202, 204, 206, and 208 (hereinafter “inputs 202 through 208”), minimum number output (“Oₘ”) 212, multiplexers 218, 222, and 226, and multiplexer controllers 220, 224, and 228. In one embodiment, minimum number module 210, inputs 202 through 208, and Oₘ 212 in FIG. 2 correspond to minimum number module 110, inputs 102 through 108, and Oₘ 112 in FIG. 1, respectively.

In the embodiment shown in FIG. 2, A and B are respectively provided to inputs “1” and “0” of multiplexer 218. As also shown in FIG. 2, multiplexer controller 220 is configured to provide a select signal, i.e., “sel_AB,” to the select input of multiplexer 218 via bus 221. In one embodiment, sel_AB can be a digital signal having one of two possible states, such as a logic “0” or a logic “1.” Thus, for example, if sel_AB is a logic 1, then input 1 of multiplexer 218 is selected and if sel_AB is a logic 0, then input 0 of multiplexer 218 is selected. In one embodiment, multiplexer controller 220 can be a logic circuit configured to receive A and B and to generate sel_AB based on a comparison of A and B. Accordingly, multiplexer controller 220 can be configured to select input 1 of multiplexer 218 if A is less than B, and to select input 0 of multiplexer 218 if A is greater than or equal to B by executing the following equation:

sel_{—}AB=f(A,B) (equation 1)

where f(A,B) is a comparison function equaling a logic 1 if A is less than B and a logic 0 in all other cases. Thus, as shown in FIG. 2, multiplexer 218 can provide the lower of A and B to input “1” of multiplexer 226.

As further shown in FIG. 2, C and D are respectively provided to inputs “1” and “0” of multiplexer 222. As shown in FIG. 2, multiplexer controller 224 is configured to provide a select signal, i.e., “sel_CD,” to the select input of multiplexer 222 via bus 225. In one embodiment, sel_CD can be a digital signal having one of two possible states, such as a logic “0” or a logic “1.” Thus, for example, if sel_CD is a logic 1, then input 1 of multiplexer 222 is selected and if sel_CD is a logic 0, then input 0 of multiplexer 222 is selected. In one embodiment, multiplexer controller 220 can be a logic circuit configured to receive C and D and to generate sel_CD based on a comparison of C and D. Accordingly, multiplexer controller 222 can be configured to select input 1 of multiplexer 222 if C is less than D, and to select input 0 of multiplexer 222 if C is greater than or equal to D by executing the following equation:

sel_{—}CD=f(C,D) (equation 2)

where f(C,D) is a comparison function equaling a logic 1 if C is less than D and a logic 0 in all other cases. Thus, as shown in FIG. 2, multiplexer 222 can provide the lower of C and D to input “0” of multiplexer 226.

As also shown in FIG. 2, multiplexer controller 228 is configured to provide a select signal, i.e., “sel_ABCD,” to the select input of multiplexer 226 via bus 229. In one embodiment, sel_ABCD can be a digital signal having one of two possible states, such as a logic “0” or a logic “1.” Thus, for example, if sel_ABCD is a logic 1, then input 1 of multiplexer 226 is selected and if sel_ABCD is a logic 0, then input 0 of multiplexer 226 is selected. In one embodiment, multiplexer controller 228 can be a logic circuit configured to receive A, B, C, and D and to generate sel_ABCD based on a comparison of A, B, C, and D. Accordingly, multiplexer controller 228 can be configured to select input 1 of multiplexer 226 if A is less than both C and D or if B is less than both C and D, and to otherwise select input 0 if neither of these conditions are met. For example, multiplexer controller 228 can perform such comparisons by executing the following equation:

sel_{—}ABCD=(f(A,C) [symbol] f(A,D)) [symbol] (f(B,C) [symbol] f(B,D)) (equation 3)

where f(A,C), f(A,D), f(B,C), and f(B,D) are each comparison functions equaling a logic 1 if the first number in the function is less than the second number and a logic 0 in all other cases. For example, and similar to the comparison functions in equations 1 and 2 described above, f(A,C) equals a logic 1 if A is less than C and a logic 0 in all other cases. Thus, as shown in FIG. 2, multiplexer 226 can effectively output the minimum of A, B, C, and D at Oₘ 212. Thus, it can be appreciated that the comparator module of the invention can determine the minimum number in a set of four numbers (i.e., A, B, C, and D) by determining the result of six comparison functions (i.e., f(A,B) f(A,C), f(A,D), f(B,C), f(B,D), and f(C,D)), which can all be determined concurrently.

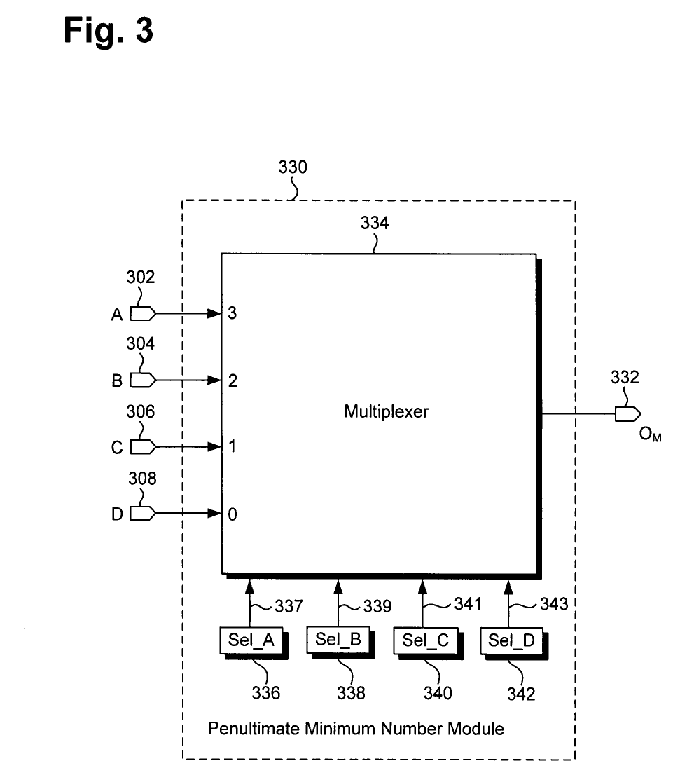

The operation of penultimate minimum number module 130 shown in FIG. 1 will now be discussed with reference to FIG. 3. FIG. 3 shows a penultimate minimum number module in accordance with one embodiment of the invention. As shown in FIG. 3, penultimate minimum number module 330 includes inputs 302, 304, 306, and 308 (hereinafter inputs “302 through 308”), penultimate minimum number output (“O_{M}”) 332, multiplexer 334, and multiplexer controllers 336, 338, 340, and 342. In one embodiment, penultimate minimum number module 330, inputs 302 through 308, and O_{M} 332 in FIG. 3 correspond to penultimate minimum number module 130, inputs 102 through 108, and O_{M} 132 in FIG. 1, respectively.

In the embodiment shown in FIG. 3, A, B, C, and D are provided to inputs 3, 2, 1, and 0 of multiplexer 334, respectively. As also shown in FIG. 3, multiplexer controllers 336, 338, 340, and 342 are configured to provide select signals to the select inputs of multiplexer 334 via respective buses 337, 339, 341, and 343. In one embodiment, multiplexer controllers 336, 338, 340, and 342 can each be a logic circuit configured to receive A, B, C, and D and to compare A, B, C, and D. As shown in FIG. 3, multiplexer controllers 336, 338, 340, and 342 can be configured to generate the select signals “sel_A,” “sel_B,” “sel_C,” and “sel_D,” respectively. Each of these select signals can be a digital signal having one of two possible states, such as a logic “0” or a logic “1.” In the embodiment shown in FIG. 3, sel_A, sel_B, sel_C, and sel_D are mutually exclusive select signals that can be used to select inputs 3, 2, 1, and 0 of multiplexer 334, respectively. For example, if sel_A is a logic 1 and sel_B, sel_C, and sel_D are all logic 0, then input 3 of multiplexer 334 can be selected, thus outputting A at O_{M} 332. As another example, if sel_C is a logic 1 and sel_A, sel_B, and sel_D are all logic 0, then input 1 of multiplexer 334 can be selected, thus outputting C at O_{M} 332.

Each multiplexer controller in FIG. 3 can be configured to compare A, B, C, and D and to determine whether the number provided to the input controlled by that multiplexer controller is the penultimate minimum number. For example, multiplexer controller 336 can be configured to determine whether A is the penultimate minimum number, multiplexer controller 338 can be configured to determine whether B is the penultimate minimum number, and so on. Once a multiplexer controller has determined a penultimate minimum number, it can generate a select signal (e.g., sel_A) indicating a logic 1, thereby enabling the penultimate minimum number to be output at O_{M} 332. For example, multiplexer controllers 336, 338, 340, and 342 can be configured to compare A, B, C, and D and to determine respective select signals sel_A, sel_B, sel_C, and sel_D, by executing the following equations:

$$\begin{matrix}sel\_A = ( f ( A , B ) ⋀ f ( A , C ) ⋀ \overline{f ( A , D )} ) ⋁ ( f ( A , B ) ⋀ \overline{f ( A , C )} ⋀ f ( A , D ) ) ⋁ ( \overline{f ( A , B )} ⋀ f ( A , C ) ⋀ ( A , D ) ) & ( equation 4 ) \\ sel\_B = ( f ( A , B ) ⋀ f ( B , C ) ⋀ f ( B , D ) ) ⋁ ( \overline{f ( A , B )} ⋀ f ( B , C ) ⋀ f ( B , D ) ) ⋁ ( \overline{f ( A , B )} ⋀ \overline{f ( B , C )} ⋀ f ( B , D ) ) & ( equation 5 ) \\ sel\_C = ( f ( A , C ) ⋀ \overline{f ( B , C )} ⋀ f ( C , D ) ) ⋁ ( \overline{f ( A , C )} ⋀ f ( B , C ) ⋀ f ( C , D ) ) ⋁ ( \overline{f ( A , C )} ⋀ \overline{f ( B , C )} ⋀ \overline{f ( C , D )} ) & ( equation 6 ) \\ sel\_D = ( f ( A , D ) ⋀ \overline{f ( B , D )} ⋀ \overline{f ( C , D )} ) ⋁ ( \overline{f ( A , D )} ⋀ f ( B , D ) ⋀ f \overline{( C , D )} ) ⋁ ( \overline{f ( A , D )} ⋀ \overline{f ( B , D )} \hat{} f ( C , D ) ) & ( equation 7 )\end{matrix}$$

where f(A,B), f(A,C), f(A,D), f(B,C), f(B,D), and f(C,D) are the comparison functions described above. For example, if A, B, C, and D represent the respective numbers 4, 7, 5, and 9, then multiplexer controller 340 would determine sel_C to be a logic 1, while multiplexer controllers 336, 338, and 342 would respectively determine sel_A, sel_B, and sel_D to be a logic 0. As such, input 1 of multiplexer 334 would be selected, thereby enabling multiplexer 334 to output the penultimate minimum number, i.e., the number 5, at O_{M} 332.

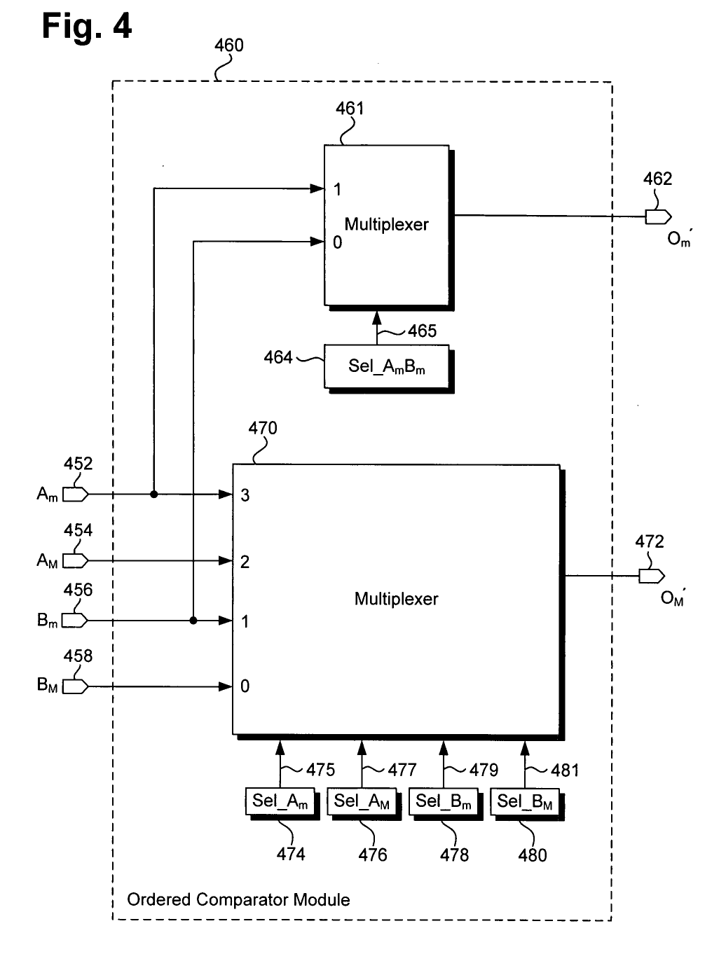

FIG. 4 shows a block diagram of an ordered comparator module for determining a minimum number and a penultimate minimum number in a set of numbers in accordance with one embodiment of the invention. As shown in FIG. 4, ordered comparator module 460 includes inputs 452, 454, 456, and 458 (hereinafter “inputs 452 through 458”), multiplexers 461 and 470, multiplexer controllers 464, 474, 476, 478, and 480, minimum number output (“Oₘ”) 462, and penultimate minimum number output (“O_{M}”) 472.

As shown in FIG. 4, ordered comparator module 460 can be configured to receive a set of numbers (represented by the variables Aₘ, A_{M}, Bₘ, and B_{M}) at inputs 452 through 458. For example, Aₘ, A_{M}, Bₘ, and B_{M} can each represent an unsigned number having an “n” number of bits, such that A_{M} is greater than Aₘ, and B_{M} is greater than Bₘ. As discussed below, ordered comparator module 460 can be configured to determine the minimum number (i.e., the lowest number) in the set of numbers and the penultimate minimum number (i.e., the second lowest number) in the set of numbers. As shown in FIG. 4, the minimum number and the penultimate minimum number in the set of numbers can be output by ordered comparator module 460 at Oₘ′ 462 and O_{M}′ 472, respectively.

The operation of ordered comparator module 460 shown in FIG. 4 will now be discussed. In the embodiment shown in FIG. 4, Aₘ and Bₘ are provided to inputs 1 and 0 of multiplexer 461, respectively. Moreover, Aₘ, A_{M}, Bₘ, and B_{M} are provided to inputs 3, 2, 1, and 0 of multiplexer 470, respectively. As shown in FIG. 4, multiplexer controller 464 is configured to generate a select signal, i.e., “sel_AₘBₘ,” and to provide the select signal to the select input of multiplexer 461 via bus 465. In one embodiment, sel_AₘBₘ can be a digital signal having one of two possible states, such as a logic “0” or a logic “1.” Thus, for example, if sel_AₘBₘ is a logic 1, then input 1 of multiplexer 461 is selected and if sel_AₘBₘ is a logic 0, then input 0 of multiplexer 461 is selected. In one embodiment, multiplexer controller 464 can be a logic circuit configured to receive Aₘ and Bₘ and to generate sel_AₘBₘ based on a comparison of Aₘ and Bₘ. Accordingly, multiplexer controller 464 can be configured to select input 1 of multiplexer 461 if Aₘ is less than Bₘ, and to select input 0 of multiplexer 461 if Aₘ is greater than or equal to Bₘ by executing the following equation:

sel_{—}AₘBₘ=f(Aₘ,Bₘ) (equation 8)

where f(Aₘ, Bₘ) is a comparison function that equals a logic 1 if Aₘ is less than Bₘ and a logic 0 in all other cases. Thus, as shown in FIG. 4, multiplexer 461 can output the lower of Aₘ and Bₘ, which is the minimum of Aₘ, A_{M}, Bₘ, and B_{M}, at Oₘ 462.

As further shown in FIG. 4, multiplexer controllers 474, 476, and 478, and 480 are configured to provide select signals to the select inputs of multiplexer 470 via respective buses 475, 477, 479, and 481. In one embodiment, multiplexer controllers 474, 476, and 478, and 480 can each be a logic circuit configured to receive Aₘ, A_{M}, Bₘ, and B_{M} and to compare Aₘ, A_{M}, Bₘ, and B_{M}. As shown in FIG. 4, multiplexer controllers 474, 476, and 478, and 480 can be configured to generate the select signals “sel_Aₘ,” “sel_A_{M},” “sel_Bₘ,” and “sel_B_{M},” respectively. Each of these select signals can be a digital signal having one of two possible states, such as a logic “0” or a logic “1.” In the embodiment shown in FIG. 4, sel_Aₘ, sel_A_{M}, sel_Bₘ, and sel_B_{M} are mutually exclusive select signals that can be used to select inputs 3, 2, 1, and 0 of multiplexer 470, respectively. For example, if sel_Aₘ is a logic 1 and sel_A_{M}, sel_Bₘ, and sel_B_{M} are all logic 0, then input 3 of multiplexer 470 can be selected, thus outputting Aₘ at O_{M}′ 472. As another example, if sel_Bₘ is a logic 1 and sel_Aₘ, sel_A_{M}, and sel_B_{M} are all logic 0, then input 1 of multiplexer 470 can be selected, thus outputting Bₘ at O_{M}′ 472.

Each multiplexer controller in FIG. 4 can be configured to compare Aₘ, A_{M}, Bₘ, and B_{M} and to determine whether the number provided to the input controlled by that multiplexer controller is the penultimate minimum number. For example, multiplexer controller 474 can be configured to determine whether Aₘ is the penultimate minimum number, multiplexer controller 476 can be configured to determine whether A_{M} is the penultimate minimum number, and so on. Once a multiplexer controller has determined a penultimate minimum number, it can generate a select signal (e.g., sel_Aₘ) indicating a logic 1, thereby enabling the penultimate minimum number to be output at O_{M}′ 472. For example, multiplexer controllers 474, 476, 478, and 480 can be configured to compare Aₘ, A_{M}, Bₘ, and B_{M} and to determine the respective select signals sel_Aₘ, sel_A_{M}, sel_Bₘ, and sel_B_{M}, by executing the following equations:

sel_{—}Aₘ= f̅(̅A̅ₘ̅,̅B̅ₘ̅)̅ [symbol] f(Aₘ,B_{M}) (equation 9)

sel_{—}A_{M}=f(Aₘ,Bₘ) [symbol] f(A_{M},Bₘ) (equation 10)

sel_{—}Bₘ=f(Aₘ,Bₘ) [symbol] f̅(̅A̅_̅{̅M̅}̅,̅B̅ₘ̅)̅ (equation 11)

sel_{—}B_{M}= f̅(̅A̅ₘ̅,̅B̅ₘ̅)̅ [symbol] f̅(̅A̅ₘ̅,̅B̅_̅{̅M̅}̅)̅ (equation 12)

where f(Aₘ,Bₘ), f(Aₘ,B_{M}), and f(A_{M}, Bₘ) are comparison functions. For example, and similar to the comparison functions described above, f(Aₘ,Bₘ) equals a logic 1 if Aₘ is less than Bₘ and a logic 0 in all other cases. For example, if Aₘ, A_{M}, Bₘ, and B_{M} represent the respective numbers 2, 5, 3, and 7, then multiplexer controller 478 would determine sel_Bₘ to be a logic 1, while multiplexer controllers 474, 476, and 480 would respectively determine sel_Aₘ, sel_A_{M}, and sel_B_{M} to be a logic 0. As such, input 1 of multiplexer 470 would be selected, thereby enabling multiplexer 470 to output the penultimate minimum number, i.e., the number 3, at O_{M}′ 472. It can be appreciated that the ordered comparator module of the invention can determine the penultimate minimum of Aₘ, A_{M}, Bₘ, and B_{M} by determining the result of three comparison functions (i.e., f(Aₘ,Bₘ), f(Aₘ,Bₘ), and f(A_{M},Bₘ)), which can all be determined concurrently.

Thus, ordered comparator module 460 is a comparator module that can be configured to receive a set of “ordered” numbers (i.e., Aₘ, A_{M}, Bₘ, and B_{M}), such that A_{M} is greater than Aₘ, and B_{M} is greater than Bₘ, to determine the minimum number and penultimate minimum number in the set of ordered numbers. Accordingly, the ordered configuration of the inputted numbers advantageously allows ordered comparator module 460 to determine the minimum number and penultimate minimum number in a set of numbers by determining the result of only three comparison functions as described above.

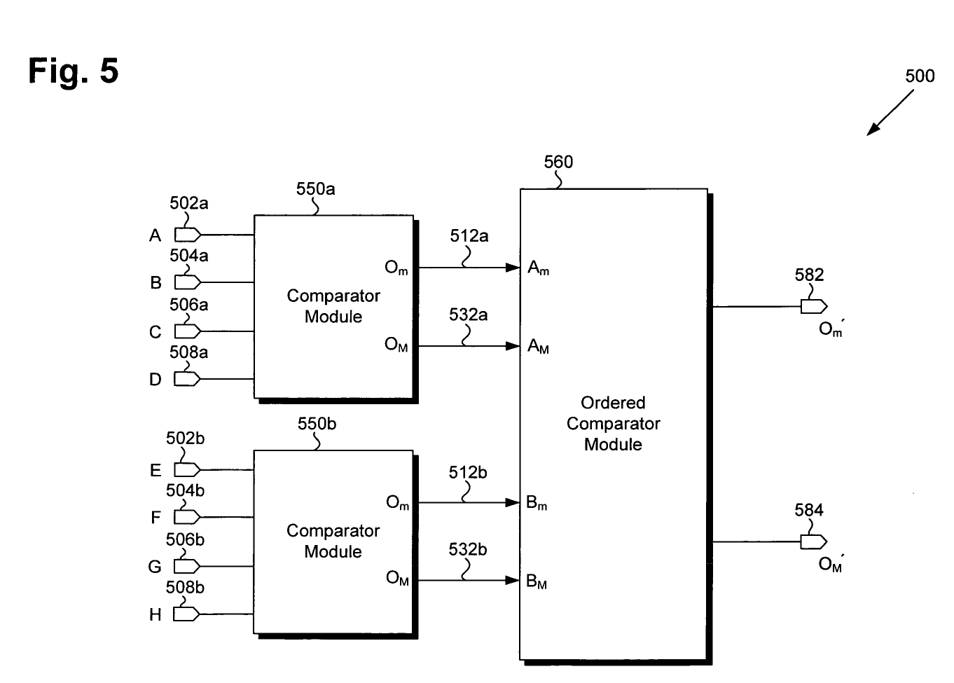

FIG. 5 shows a system for determining a minimum number and a penultimate minimum number in a set of numbers in accordance with one embodiment of the present invention. System 500 includes comparator modules 550a and 550b, and ordered comparator module 560. As shown in FIG. 5, comparator module 550a has inputs 502a, 504a, 506a, and 508a, and comparator module 550b has inputs 502b, 504b, 506b, and 508b. As also shown in FIG. 5, ordered comparator module 560 has minimum number output (“Oₘ′”) 582 and penultimate minimum number output (“O_{M}′”) 584. In one embodiment, comparator modules 550a and 550b in FIG. 5 each correspond to comparator module 150 in FIG. 1, and ordered comparator module 560 corresponds to ordered comparator module 460 in FIG. 4.

System 500 in FIG. 5 can be configured to determine the minimum number and the penultimate minimum number in a set of numbers. For example, the variables A through H shown in FIG. 5 can collectively represent an example set of numbers, where each variable represents an unsigned number having an “n” number of bits. As shown in FIG. 5, the set of numbers can be divided to form a first subset (i.e., the subset including A, B, C, and D) and a second subset (i.e., the subset including E, F, G, and H). As further shown in FIG. 5, each comparator module can be configured to receive a subset of numbers and to determine the minimum number and penultimate minimum number in the corresponding subset using the techniques described above. For example, comparator module 550a can receive A, B, C, and D at respective inputs 502a, 504a, 506a, and 508a and comparator module 550b can receive E, F, G, and H at respective inputs 502b, 504b, 506b, and 508b. Thereafter, comparator module 550a can output the minimum number and penultimate minimum number in A, B, C, and D at outputs 512a and 532a, respectively. Likewise, comparator module 550b can output the minimum number and penultimate minimum number in E, F, G, and H at outputs 512b and 532b, respectively.

As further shown in FIG. 5, the minimum numbers and penultimate minimum numbers output by comparator modules 550a and 550b are provided to ordered comparator module 560. As shown in FIG. 5, ordered comparator module 560 can receive the minimum number and penultimate minimum number determined by comparator 550a at inputs “Aₘ” and “A_{M},” respectively. Similarly, ordered comparator module 560 can receive the minimum number and penultimate minimum number determined by comparator 550b at inputs “Bₘ” and “B_{M},” respectively. Thereafter, ordered comparator module 560 can be configured to determine the minimum number and the penultimate minimum number of the received numbers and to output the minimum number and penultimate minimum number at Oₘ′ 582 and O_{M}′ 584, respectively. Thus, the minimum number and penultimate minimum number output at Oₘ′ 582 and O_{M}′ 584, respectively, represent the minimum number and penultimate minimum number for the entire set of numbers (i.e., A through H). In one embodiment, the minimum number and penultimate minimum number determined by system 500 can be used in a min-sum algorithm for decoding low density parity check (“LDPC”) codes.

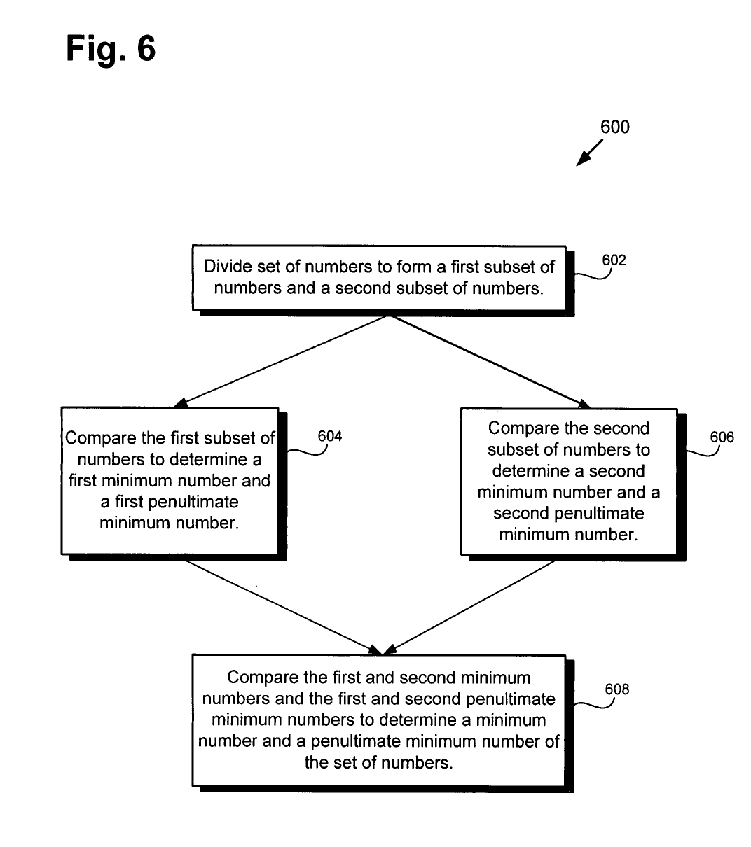

FIG. 6 illustrates flowchart 600 for performing an example method for determining a minimum number and a penultimate minimum number in a set of numbers in accordance with one embodiment of the present invention. With reference to the embodiment of the invention shown in FIG. 5 and as shown in FIG. 6, at step 602 of flowchart 600, the set of numbers is divided to form a first subset of numbers and a second subset of numbers. Then, at step 604, the first subset of numbers is compared to determine a first minimum number and a first penultimate minimum number. In one embodiment, concurrently with step 604, at step 606, the second subset of numbers is compared to determine a second minimum number and a second penultimate minimum number. However, in another embodiment, steps 604 and 606 may not be performed concurrently. At step 608, the first and second minimum numbers and the first and second penultimate minimum numbers are compared to determine the minimum number and penultimate minimum number of the set of numbers.

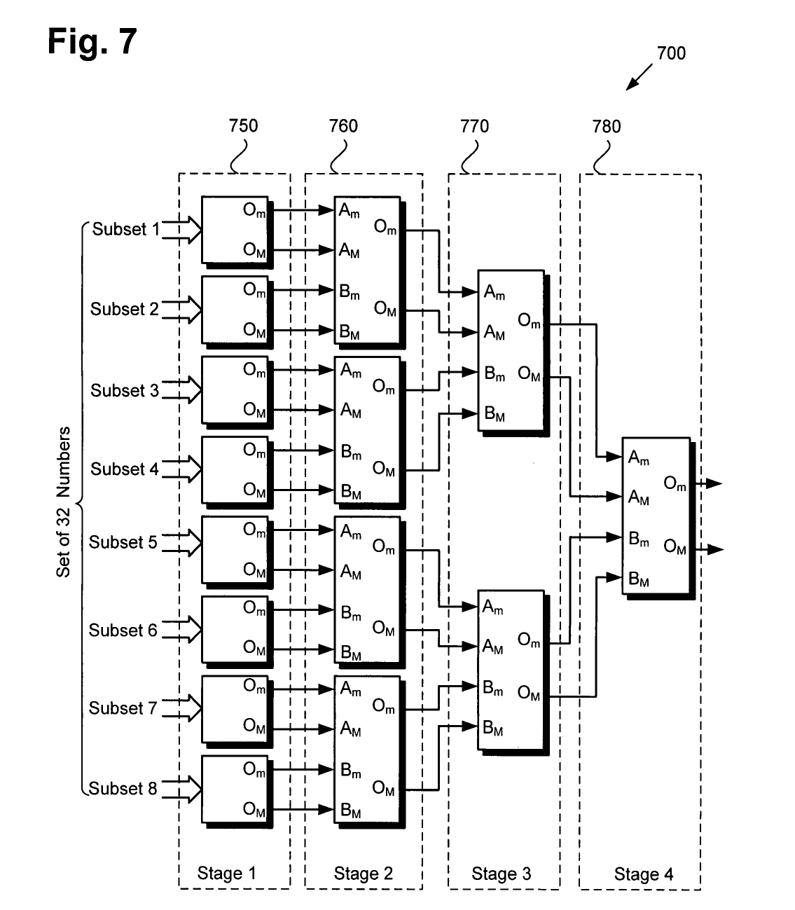

FIG. 7 shows a system for determining the minimum number and the penultimate minimum number in a set of numbers. System 700 includes comparator stage 750 (also referred to as “stage 1”), ordered comparator stage 760 (also referred to as “stage 2”), ordered comparator stage 770 (also referred to as “stage 3”), and ordered comparator stage 780 (also referred to as “stage 4”). As shown in FIG. 7, system 700 is configured to determine the minimum and penultimate minimum numbers in a set of 32 randomly arranged numbers. In the embodiment shown in FIG. 7, the 32 numbers are divided into 8 subsets, such that each subset includes four numbers. As further shown in FIG. 7, each subset is input to a corresponding comparator module in stage 1. The minimum and penultimate minimum numbers determined by each comparator module for each subset in stage 1 are then provided to a corresponding ordered comparator module in stage 2. As shown in FIG. 7, the minimum and penultimate minimum numbers determined by each ordered comparator module in stage 2 are then provided to a corresponding ordered comparator module in stage 3. The ordered comparator module in stage 4 then receives the minimum and penultimate minimum numbers determined in stage 3 to output the minimum and penultimate minimum numbers in the set of 32 numbers. Thus, each stage of ordered comparator modules in FIG. 7 (i.e., stages 2, 3, and 4) is advantageously configured to determine the minimum and penultimate minimum numbers in a set of numbers received from a preceding stage, thereby allowing system 700 to quickly determine the minimum and penultimate minimum numbers in the set of 32 numbers.

Thus, the present invention provides significant advantages. For example, since the comparator modules of the present invention allows the determination of a minimum number and a penultimate minimum number in a set of numbers by concurrently determining a few comparison functions, the present invention provides a quick and efficient way of determining the minimum number and penultimate minimum number in a set of numbers. Moreover, since the comparator modules of the present invention can be implemented using, for example, 2-input and 4-input multiplexers, the present invention can be implemented at low costs.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for determining a minimum number and a penultimate minimum number in a set of numbers, said method comprising:
dividing said set of numbers to form a first subset of numbers and a second subset of numbers;
inputting said first subset of numbers to a first comparator module;
comparing said first subset of numbers using said first comparator module to determine a first minimum number and a first penultimate minimum number among said first subset of numbers;
inputting said second subset of numbers to a second comparator module;
comparing said second subset of numbers using said second comparator module to determine a second minimum number and a second penultimate minimum number;
inputting said first and second minimum numbers and said first and second penultimate minimum numbers to a third comparator module;
comparing said first minimum number and said second minimum number using said third comparator module to determine said minimum number; and
comparing said first penultimate minimum number and said second penultimate minimum number using said third comparator module to determine said penultimate minimum number;
outputting said minimum number and said penultimate minimum number.

2. The method of claim 1 wherein said comparing said first subset of numbers and said comparing said second subset of numbers are performed concurrently.

3. The method of claim 1 wherein said set of numbers comprises a plurality of unsigned numbers having an “n” number of bits.

4. The method of claim 1 wherein said first comparator module and said second comparator module each include a minimum number module and a penultimate minimum number module.

5. The method of claim 4 wherein said minimum number module and said third comparator module each include a plurality of multiplexers.

6. The method of claim 4 wherein said penultimate minimum number module includes at least one multiplexer.

7. The method of claim 1 wherein said first subset of numbers and said second subset of numbers each include four numbers.

8. The method of claim 7 wherein said comparing said first subset of numbers and said comparing said second subset of numbers each include determining six comparison functions concurrently.

9. The method of claim 7 wherein said comparing said first and second minimum numbers and said comparing said first and second penultimate minimum numbers include determining three comparison functions concurrently.

10. The method of claim 1 wherein said minimum number and said penultimate minimum number are used in a min-sum algorithm for decoding low density parity check (“LDPC”) codes.

11. A system for determining a minimum number and a penultimate minimum number in a set of numbers, said system comprising:
a first comparator module configured to receive a first subset of said set of numbers and to compare said first subset to determine a first minimum number and a first penultimate minimum number;
a second comparator module configured to receive a second subset of said set of numbers and to compare said second subset to determine a second minimum number and a second penultimate minimum number;
a third comparator module configured to receive and compare said first and second minimum numbers to determine said minimum number, and configured to receive and compare said first and second penultimate minimum numbers to determine said penultimate minimum number.

12. The system of claim 11 wherein said first and second comparator modules each include a minimum number module and a penultimate number module.

13. The system of claim 12 wherein said minimum number module and said third comparator module each include a plurality of multiplexers, and wherein said penultimate minimum number module includes at least one multiplexer.

14. The system of claim 12 wherein said minimum number module, said penultimate minimum module, and said third comparator module each include a plurality of multiplexer controllers.

15. The system of claim 11 wherein said first and second comparator modules are each configured to determine six comparison functions concurrently.

16. The system of claim 11 wherein said third comparator module is configured to determine three comparison functions concurrently.

17. The system of claim 11 wherein said first and second subsets each include an equal number of numbers.

18. The system of claim 17 wherein said first and second subsets each include four numbers.

19. The system of claim 11 wherein said set of numbers comprises a plurality of unsigned numbers having an “n” number of bits.

20. The system of claim 11 wherein said minimum number and said penultimate minimum number are used in a min-sum algorithm for decoding low density parity check (“LDPC”) codes.
